(19) United States
(12) Patent Application Publication
(10) Pub. No.: US 2004/0260525 A1
(43) Pub. Date: Dec. 23, 2004

(54) Designing a component that vibrates in use

(76) Inventor: Caetano Peng, Derby (GB)

Correspondence Address: MANELLI DENISON & SELTER, 2000 M STREET NW SUITE 700, WASHINGTON, DC, 20036-3307, US

(21) Appl. No.: 10/852,115

(22) Filed: May 25, 2004

(30) Foreign Application Priority Data
Jun. 20, 2003 (GB) 0314404.5

(51) Int. Cl. G06G 7/48

(52) U.S. Cl. 703/7

(57) ABSTRACT

A method of designing a component that vibrates in use, comprising the steps of, repeatedly: a) analysing (20) a component design to determine a critical vibration mode of the component, wherein the critical vibration mode is the vibration mode at which stress in the component design is maximal; and then b) varying (30, 32) the component design to reduce the stress in the component at the critical vibration mode.

Embodiments of the present invention relate to the design of a component that vibrates in use. In particular they relate to the design of a blade for a gas turbine engine.

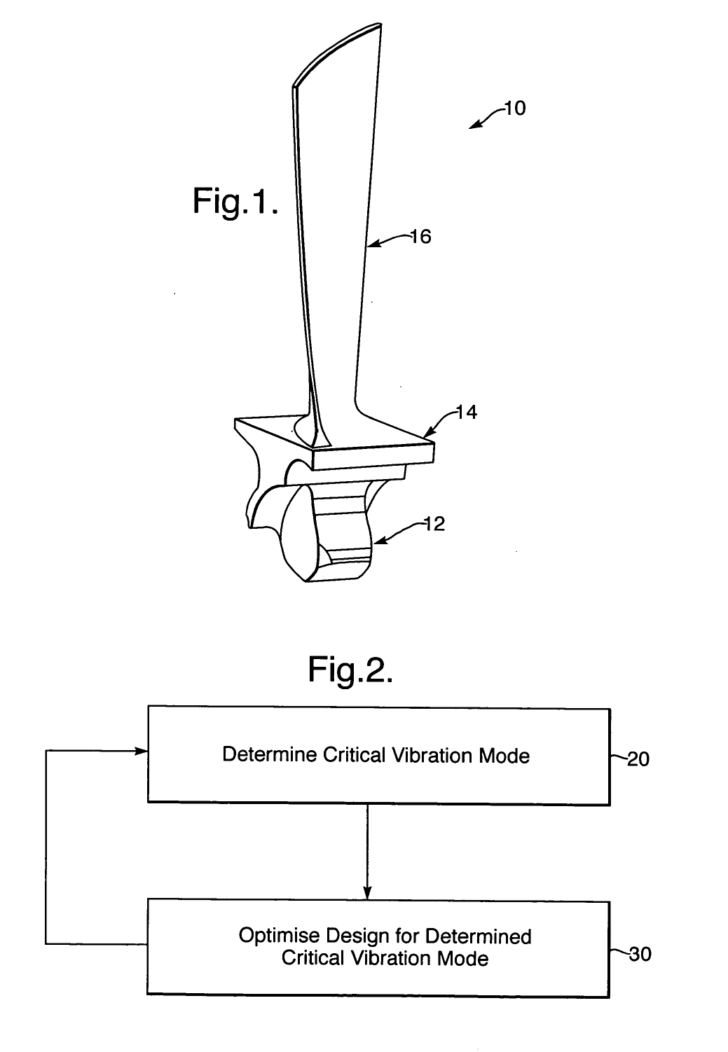

FIG. 1 illustrates a blade 10 suitable for use in a gas turbine engine. The blade 10 is unitary but can be divided for design purposes into three separate sub-components: the root 12, the platform 14 and the aerofoil 16. The root 12 connects the blade 10 to a disc-drum of an engine. The platform 14 lies between the root 12 and the aerofoil 16.

Excessive blade root modal vibration stresses during engine operation can lead to blade root failures via high-cycle fatigue (HCF).

There is, at present, no analytical technique, for controlling vibration stresses in blade roots and other engine components. Current design practice tends to be conservative by over-designing the blade root to prevent failure. However, this results in an increased engine mass, which is particularly undesirable for gas turbine aero-engines.

According to one aspect of the present invention there is provided a method of designing a component that vibrates in use, characterised in that it comprises the steps of:

a) analysing a component design to determine a critical vibration mode of the component, wherein the critical vibration mode is the vibration mode at which stress in the component design is maximal; and then

b) varying the component design to reduce the stress in the component at the critical vibration mode.

According to another aspect of the present invention there is provided a computer program for designing a component that vibrates in use, characterised in that it comprises program instructions for:

a) analysing a component design to determine a critical vibration mode of the component, wherein the critical vibration mode is the vibration mode at which stress in the component design is maximal; and then

b) varying the component design to reduce the stress at the critical vibration mode.

According to a further aspect of the present invention there is provided a computerised system for designing a component that vibrates in use, characterised in that it comprises:

a) analysis means for analysing a component design to determine a critical vibration mode of the component, wherein the critical vibration mode is the vibration mode at which stress in the component design is maximal; and

b) modification means for automatically varying the component design to reduce the stress at the critical vibration mode.

For a better understanding of the present invention reference will now be made by way of example only to the accompanying drawings in which:

FIG. 1 illustrates a blade 10 suitable for use in a gas turbine engine;

FIG. 2 illustrates a method of designing a component of an engine;

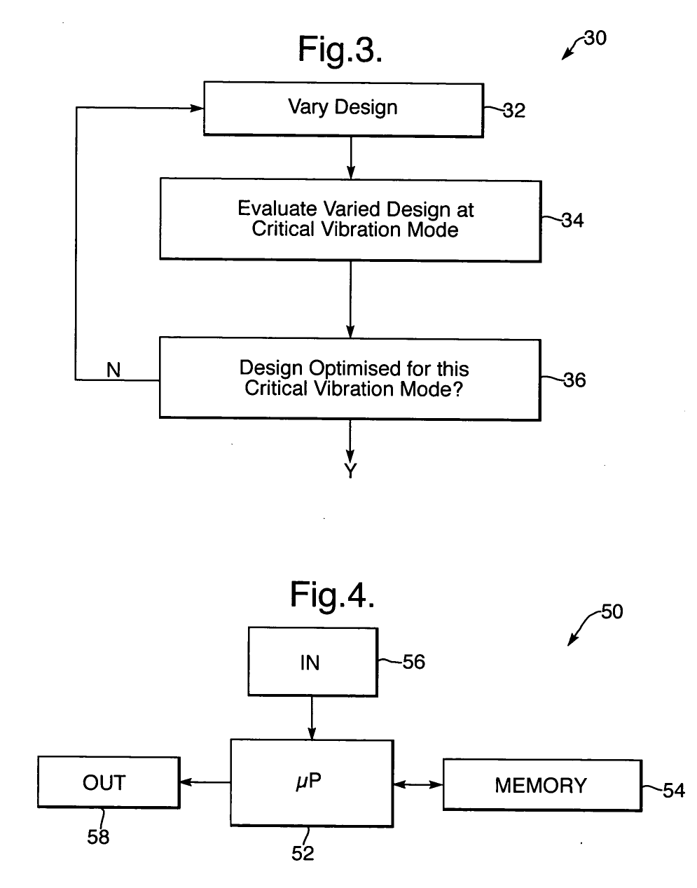

FIG. 3 illustrates the optimisation step 30 of FIG. 2 in more detail; and

FIG. 4 illustrates a computerised system 50 for automatically designing a component of an engine.

The Figures illustrate a method of designing a component that vibrates in use, comprising the steps of: analysing (20) a component design to determine a critical vibration mode of the component, wherein the critical vibration mode is the vibration mode at which stress in the component design is maximal; and then varying (30) the component design to reduce the stress in the component at the critical vibration mode.

FIG. 2 illustrates a method of designing a component of an engine, in this case a blade for a gas turbine engine. The method involves an iterative process. Steps 20 and 30 are cyclically repeated until a finalised design is obtained.

Step 20, involves evaluating the blade design to determine a critical vibration mode of the component using finite element analysis. Commercial finite element analysis programs such as ‘ABAQUS’ may be used. The critical vibration mode is the vibration mode at which stress in the component design is maximal.

Step 30 involves optimising the component design to obtain the design with the lowest maximum stress at the critical vibration mode.

The optimisation step 30 is illustrated in more detail in FIG. 3. The optimisation step 30 involves a series of multiple iterations. Each iteration includes a variation 32 in the component design and an evaluation 34 of the varied design at the critical vibration mode. The design is varied by systematically changing the relative positions of the aerofoil, platform and root. The varied design is evaluated by determining the maximum stress at the critical vibration mode for the varied design using finite element analysis. The varied design with the lowest maximum stress at the critical vibration mode is selected 36 as an adapted blade design.

After step 30 in FIG. 2, control returns to step 20. The adapted blade design is evaluated using finite element analysis to determine the maximal stress in the blade. If the maximal stress exceeds a threshold, then the critical vibration mode of the adapted blade design goes through a similar iterative design process as described in the preceding paragraphs. If the maximal stress does not exceed threshold, then the adapted design is accepted as a new design and is provided as an output.

FIG. 4 illustrates a computerised system 50 for automatically designing a component of an engine, in this case a blade for a gas turbine engine. The system 50 comprises a processor 52, a memory 54, an input 56 and an output 58. The operation of the processor 52 is controlled by loaded computer instructions. The processor 52 and memory 54 provide analysis means for analysing a component design to determine the critical vibration mode of the component and modification means for automatically varying the component design to reduce the stress at the critical vibration mode. The processor 52 carries out the process described with reference to FIGS. 2 and 3 automatically and provides the new design at the output 58. The input 56 may be a user input. The user input contains the initial component design model and it may be used to place constraints upon the optimisation procedure, for example, limiting the extent to which the aerofoil, platform and root can be moved relative to each other.

The computer program may be loaded into the system 50 via a record medium or an electromagnetic carrier signal. It may be stored in memory 54 in the system 50.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I claim:

1. A method of designing a component that vibrates in use, characterised in that it comprises the steps of:
a) analysing a component design to determine a critical vibration mode of the component, wherein the critical vibration mode is the vibration mode at which stress in the component design is maximal; and then
b) varying the component design to reduce the stress in the component at the critical vibration mode.

2. A method as claimed in claim 1, wherein the step b) includes varying the relative positions of parts of the component.

3. A method as claimed in claim 2, wherein the component is a blade for a gas turbine engine and the parts of the component include at least an aerofoil and a root.

4. A method as claimed in claim 1, wherein the step b) includes optimising the component design to obtain the design with the lowest maximal stress at the critical vibration mode.

5. A method as claimed in claim 1, wherein the step b) includes a series of iterations, wherein each iteration includes a variation in the component design and the analysis of the varied design to determine the stress at the critical vibration mode for the varied design, and a selection of one of the varied designs.

6. A method as claimed in claim 5, wherein the selection is of the varied design with the lowest maximal stress at the critical vibration mode.

7. A method as claimed in claim 1, wherein the step a) uses finite element analysis for analysing a component design to determine a critical vibration mode of the component.

8. A method as claimed in claim 1, further comprising the steps of:
c) after step b), analysing the varied component design to determine a critical vibration mode, wherein the critical vibration mode is the vibration mode for which the stress in the varied component design is maximal; and then
d) varying the varied component design to reduce the stress at the critical vibration mode.

9. A method as claimed in claim 8, wherein the critical vibration mode determined in step a) is different to the critical vibration mode determined in step c).

10. A method as claimed in claim 8, wherein the step d) includes varying the relative positions of parts of the component.

11. A method as claimed in claim 8, wherein the step d) includes optimising the component design to obtain the design with the lowest maximal stress at the critical vibration mode.

12. A method as claimed in claim 8, wherein the step d) includes a series of iterations, wherein each iteration includes a variation in the component design and the analysis of the varied design to determine the stress at the critical vibration mode for the varied design, and a selection of one of the varied designs.

13. A method as claimed in claim 12, wherein the selection is of the varied design with the lowest maximal stress at the critical vibration mode.

14. A method as claimed in claim 8, wherein the step c) uses finite element analysis for analysing a component design to determine a critical vibration mode of the component.

15. A computer program comprising program instructions for causing a computer to perform the method of claim 1.

16. A computer program for designing a component that vibrates in use, characterised in that it comprises program instructions for:
a) analysing a component design to determine a critical vibration mode of the component, wherein the critical vibration mode is the vibration mode at which stress in the component design is maximal; and then
b) varying the component design to reduce the stress at the critical vibration mode.

17. A computer program as claimed in claim 15 embodied on a record medium, stored in a computer memory, or carried on an electromagnetic carrier signal.

18. A computerised system for designing a component that vibrates in use, characterised in that it comprises:
a) analysis means for analysing a component design to determine a critical vibration mode of the component, wherein the critical vibration mode is the vibration mode at which stress in the component design is maximal; and
b) modification means for automatically varying the component design to reduce the stress at the critical vibration mode.
